(19) United States
(12) Patent Application Publication
(10) Pub. No.: US 2026/0319470 A1
(43) Pub. Date: Oct. 15, 2026

(54) Method and System for Checking and Fault-Correcting in the Manufacturing of an Assembly for a Passenger Transport System, and Control Unit for the System

(71) Applicant: INVENTIO AG, Hergiswil (CH)

(72) Inventor: Thomas Novacek, Schwechat (CH)

(21) Appl. No.: 19/483,584

(22) PCT Filed: Jul. 3, 2024
(86) PCT No.: PCT/EP2024/068745

§ 371 Date: Nov. 11, 2025

(30) Foreign Application Priority Data
Jul. 13, 2023 (EP) 23185223.7

(51) Int. Cl. G05B 19/418; B66B 19/00

(52) U.S. Cl. CPC G05B 19/4184; G05B 19/41805; B66B 19/00

(57) ABSTRACT

A method for checking and fault-correcting in the manufacturing of an assembly for a passenger transport system is proposed. The method comprises: reception of assembly data, which are representative of an actual state of the assembly; comparison of the received assembly data with a digital double of the assembly, the digital double being representative of a target state of the assembly; generation of a release signal that is representative of the actual state corresponding to the target state, if the comparison shows that the actual state corresponds to the target state; and generation of an error signal that is representative of a deviation of the actual state from the target state, if the comparison shows that the actual state does not correspond to the target state.

### CROSS-REFERENCE TO RELATED APPLICATIONS

This application is a national phase entry under 35 U.S.C. § 371 of the international patent application PCT/EP2024/068745 filed on Jul. 3, 2024 and published under the publication number WO 2025/012051 A1, claiming priority right from the European patent application EP 23185223.7 filed on Jul. 13, 2023.

### FIELD OF THE INVENTION

The present invention relates to a method for checking and fault-correcting in the manufacturing of an assembly for a passenger transport system, which is configured as an elevator, escalator or a moving walkway, a control unit, which executes the method, and a system with the control unit for checking and fault-correcting in the manufacturing of the assembly for the passenger transport system.

### BACKGROUND OF THE INVENTION

Passenger transport systems are used to transport passengers or loads at or in buildings, for example between different height levels or within a constant height level. For example, escalators—also referred to as moving stairs—and elevators are used to transport passengers in a building from one floor to another floor. Moving walkways can be used to transport passengers within a floor in a horizontal plane or merely a slightly inclined plane.

In the manufacturing of passenger transport systems, multiple assemblies are usually assembled from individual components. These assemblies can optionally be assembled, in particular prefabricated, into larger assemblies. In extreme cases, an assembly can correspond to a prefabricated passenger transport system, i.e., a passenger transport system that has not yet been installed at its destination. In this case, the passenger transport system comprises a single assembly that only needs to be installed at its destination in order to complete the passenger transport system.

For example, a support structure of an escalator or a moving walkway can form an assembly of the escalator or the moving walkway that can be prefabricated. Escalators and moving walkways generally have such structures as load-bearing structures. The support structure can be designed to absorb forces acting on the passenger transport system when transporting passengers, in particular weight forces, and to transmit them, for example, to supporting structures of the building accommodating the passenger transport system. Suitable support points for supporting the support structure can be provided on the building. Depending on the configuration, the support structure can extend over two or more levels or floors of the building and/or over shorter or longer distances within a constant floor within the building. Support structures for passenger transport systems are usually designed as truss structures. Such truss structures are conventionally manufactured as a single assembly by the manufacturer or are divided into multiple assemblies. The pre-assembled support structure, as a complete assembly or divided into multiple assemblies, is then transported in the building in which the passenger transport system is to be installed, and is installed there.

In the case of elevator systems, assemblies can also be prefabricated by the manufacturer and transported to the destination in a prefabricated state. In particular, it is known to prefabricate drive modules and/or elevator cars and/or shaft modules of the elevator systems as assemblies before they are transported to the relevant construction site.

At the end of the production line and/or before the prefabricated assemblies are packaged and/or loaded for transport, it is useful to subject the assemblies to a thorough inspection. In particular, it can be checked whether all components of the assemblies are correctly arranged, aligned, and/or connected to one another. This can be a very time-consuming process that typically requires at least one experienced employee, which can lead to increased production costs. It is also known to adapt a passenger transport system during production to customer requirements and to the circumstances of the destination, which is also referred to as “commissioning.” For example, EP 3 724 118 B1 describes the commissioning of a passenger transport system with the help of a digital twin.

There may be a need to simplify the checking and fault-correcting in the manufacturing of an assembly for a passenger transport system and/or to carry it out more cost-effectively and to achieve greater certainty that an actual state of the assembly corresponds to a target state of the assembly.

A need of this kind can be met by the subject-matters according to the independent claims. Advantageous embodiments are explained both in the dependent claims and in the description below.

### SUMMARY OF THE INVENTION

According to a first aspect of the invention, a method for checking and fault-correcting in the manufacturing of an assembly for a passenger transport system, which is configured as an elevator, escalator or a moving walkway, is described. The method comprises: reception of assembly data, which are generated by one or more sensors and which represent an actual state of the assembly; comparison of the received assembly data with a digital double of the assembly in a control unit, the digital double representing a target state of the assembly; generation of a release signal by the control unit, which release signal represents the actual state corresponding to the target state, if the comparison shows that the actual state corresponds to the target state; and generation of an error signal by the control unit, which error signal represents a deviation of the actual state from the target state, if the comparison shows that the actual state does not correspond to the target state. The method also comprises the further step of: generation of a provision signal based on the error signal if the deviation is due to a component being missing from the assembly, the provision signal representing the missing component. The method also comprises the further step of: sending of the provision signal to a provision device, which is configured to retrieve the missing component from a warehouse and to provide it at a removal station.

According to a second aspect of the invention, a control unit for the system for checking and fault-correcting in the manufacturing of the assembly for the passenger transport system is described. The control unit has a storage unit for storing the assembly data of the passenger transport system, the assembly data representing the actual state of the assembly, and for storing the digital double of the assembly. The control unit also has a program stored at least temporarily in the storage unit, with the method described according to the first aspect of the invention, and a processor, which is communicatively coupled to the storage unit and which is configured to execute the method implemented in the program.

According to a third aspect of the invention, a system for checking and fault-correcting in the manufacturing of the assembly for the passenger transport system is described. The system comprises one or more sensors configured to generate assembly data representing the actual state of the assembly, and the control unit described according to the second aspect of the invention.

### DETAILED DESCRIPTION OF THE INVENTION

It should be noted that some of the possible features and advantages of the invention are described herein with reference to the different aspects and to different embodiments of the aspects. In particular, possible features and advantages of the invention are described partly with reference to embodiments of the method, partly with reference to embodiments of the control unit, and partly with reference to embodiments of the system. A person skilled in the art will recognize that the features described for individual embodiments can be appropriately applied to other embodiments and/or other aspects, and that features can be appropriately combined, adapted, and/or exchanged to arrive at further embodiments of the invention.

The method can, for example, be carried out by the control unit of the system for checking and fault-correcting in the manufacturing of the assembly for the passenger transport system, in particular automatically, i.e., without human intervention. In particular, the control unit can receive the assembly data, compare the received assembly data with the digital double, and generate the release signal and/or generate the error signal. The release signal can, for example, be transmitted from the control unit to a display unit, which can be used to indicate to a technician that the assembly of the passenger transport system is in perfect condition. The display unit can be part of the system. The display unit may, for example, have an optical and/or an acoustic display. The optical display can, for example, be a system monitor, AR (augmented reality) glasses, a tablet computer, a laptop or a mobile phone of the technician. In this context, the deviation can be displayed on the optical display in a manner superimposed on reality, i.e., in the form of augmented reality (AR). The optical display can show the assembly and the assembly's surroundings in real time and can also display markings and, if necessary, further information at the points where the actual state deviates from the target state. The assembly and the surroundings can be recorded, for example, by means of a camera of the device that has the optical display. Alternatively, the deviation can be displayed on the digital double on the optical display. The acoustic display can, for example, be a loudspeaker. The error signal can be transmitted from the control unit to one or more other units, as explained in more detail below.

The method can be carried out simply, automatically, quickly and cost-effectively. The method makes it possible to detect the deviation of the actual state from the target state automatically and precisely. As a result, it is easily possible to eliminate the deviation, for example automatically, so that the actual state corresponds to the target state. The method can thus help ensure that the actual state of the assembly corresponds to the target state of the assembly. Accordingly, the control unit and the system also make it possible to detect the deviation of the actual state from the target state automatically and precisely. As a result, it is again easily possible to eliminate the deviation, for example automatically, so that the actual state corresponds to the target state. The control unit and the system can thus also help ensure that the actual state of the assembly corresponds to the target state of the assembly.

The digital double can also be referred to as a digital twin. The digital double is represented by a corresponding digital data set, for example referred to as the twin data. The twin data can be stored in the storage unit and retrieved by the processor when needed. The digital double can, for example, be generated and stored as described in the prior art mentioned at the outset.

The comparison of the received assembly data with the digital double can in particular comprise finding one or more differences between the received assembly data and the digital double. An example is a flange that is bolted on with six screws, but only five screws have been installed. The empty screw hole can be detected during the comparison and can be indicated to the technician by means of the error signal. In particular, the technician can be shown a designation of the missing component as well as the necessary assembly steps, for example a torque required for fastening and/or the application of an anaerobic locking adhesive. The required material can be automatically provided at a removal station, where the inspector can remove it and install it according to the displayed instructions. This post-processing data is also transferred to the digital twin.

The comparison of the received assembly data with the digital double is carried out automatically. This automatic comparison can be performed using a conventionally programmed algorithm. Alternatively, the automatic comparison can be performed by means of artificial intelligence and/or machine learning. For example, a program for creating the digital double can create a plurality of digital doubles in which one or more components are missing or too many, and/or are not installed as intended. These “faulty” digital doubles can then be used to train the artificial intelligence so that, after training, the artificial intelligence is able to detect one or more deviations of the actual state from the target state on the basis of the received assembly data and the digital double.

According to one embodiment, the method comprises, before the reception of the assembly data: sending of an activation signal to one or more sensors, which are designed to record the actual state of the assembly of the passenger transport system in response to receiving the activation signal. Illustratively speaking, the scanning process by means of the sensors can be initiated by the control unit by the control unit sending the activation signal to the sensors. After receiving the activation signal, the sensor(s) record the actual state of the assembly of the passenger transport system. The recording of the assembly of the passenger transport system comprises scanning the assembly by means of the sensor(s). The scanning may, for example, comprise optical scanning by means of an optical sensor and/or acoustic scanning by means of an acoustic sensor. The optical sensor can, for example, be a radiation sensor that detects electromagnetic radiation, for example in the visible light spectrum or in the infrared range. Thus, the optical sensor can be, for example, a light sensor or an infrared sensor. The acoustic sensor can, for example, be a microphone that detects acoustic waves, for example in the audible range or in the ultrasonic range. Thus, the acoustic sensor can be, for example, a microphone or an ultrasonic sensor. The sensor used can, for example, be a CCV sensor, a lidar sensor, a radar sensor, a time-of-flight sensor, a PMD sensor, and the like.

According to one embodiment, the method comprises, before sending the activation signal: reception of a start signal, the start signal being representative of the actual state of the assembly of the passenger transport system being recordable. Before recording the actual state of the assembly, the assembly can be arranged in the system used for checking and fault-correcting in the manufacturing of the assembly for the passenger transport system. For example, for recording the actual state, the assembly can be arranged on a dedicated placement unit of the system. The placement unit can be part of a transport device for transporting the assembly. The placement unit represents a measuring station for three-dimensional, in particular optical, recording of the assembly.

As a result, the start signal can be generated manually by means of a corresponding input, for example by a technician via an input unit, or automatically, for example by means of one or more sensors, for example the aforementioned sensors, when the assembly is arranged as intended in the system for checking and fault-correcting in the manufacturing of the assembly. This ensures that the actual state of the assembly is recorded only if the assembly is arranged as intended in the system for checking and fault-correcting in the manufacturing of the assembly.

According to one embodiment, the method further comprises: generation of a display signal depending on the error signal, the display signal being representative of where and/or how the actual state deviates from the target state; and sending of the display signal to the display unit, which is designed to display the deviation of the actual state from the target state in response to receiving the display signal. This makes it possible for the technician to be informed in a particularly simple and intuitive way via the optical display as to where and which deviations exist. This can help the technician to correct the deviation quickly and easily. The display signal being generated depending on the error signal can, in the simplest case, mean that the error signal is used as the display signal. This is possible if the display unit is able to correctly interpret the error signal. Otherwise, the display signal can be generated depending on the error signal, the display signal being generated in a format that can be correctly interpreted by the display unit and that contains the same information content as the error signal, namely, which deviation exists, and where.

According to one embodiment, the provision signal is sent to a provision device, which is designed to retrieve the missing component from a warehouse and to provide it at a removal station. This makes it possible, in the event of a missing component, to automatically provide the missing component to the technician or an assembly robot for assembling the assembly. The provision signal being generated depending on the error signal can, in the simplest case, mean that the error signal is used as the provision signal. This is possible if the provision device is able to correctly interpret the error signal. Otherwise, the provision signal can be generated depending on the error signal, the provision signal being generated in a format that can be correctly interpreted by the provision device and that contains the same information content as the error signal, namely, which component is missing. The provision device can, for example, comprise a warehouse robot, which is designed, in response to receiving the provision signal, to automatically retrieve the component from the warehouse and to provide it at the removal station.

According to one embodiment, the method further comprises: checking whether the same deviation has already occurred in previously inspected similar assemblies, depending on the error signal; checking whether a number of the previously occurred identical deviations is greater than a specified threshold value if the same deviation has already occurred in previously inspected similar assemblies; determination of a cause of the deviation if the number is greater than the specified threshold value; determination of a procedure for eliminating the cause; and generation of an instruction signal that is representative of the procedure for eliminating the cause. This can help prevent the deviation from occurring again in the future. The deviations of the previously inspected similar assemblies can, for example, be stored in a storage unit of the control unit and retrieved from the storage unit when checking whether the same deviation has already occurred in previously inspected similar assemblies. These test steps can be understood as error analysis and error correction. In particular, this error analysis and fault-correcting can be used to analyze and correct processes of an assembly robot and/or errors in a procurement system or logistics system. During this error analysis, appropriate measures for correcting the errors can be recommended, for example by a corresponding AI module. The AI module can be trained using simulated data, historical data, and/or the digital double.

The threshold value can be specified by the manufacturer of the passenger transport system. The instruction signal can be a signal for the optical display, which, in response to receiving the instruction signal, recommends to the technician the procedure for eliminating the cause. Alternatively, the instruction signal can be a signal for the assembly robot, which, in response to receiving the instruction signal, makes at least one change in the assembly of future similar assemblies.

If the same deviation has not yet occurred in previously inspected similar assemblies, checking whether the number of previously occurred identical deviations is greater than the specified threshold value, and the subsequent determination of the cause, determination of the procedure, and generation of the instruction signal can be omitted. If the number is not greater than the specified threshold value, the determination of the cause, the determination of the procedure, and the generation of the instruction signal can be omitted.

According to one embodiment, the method further comprises: generation of at least one control signal for an actuator, which is designed to change the actual state of the assembly on the basis of the digital double; and sending of the control signal to the actuator. The actuator can, for example, be a manufacturing robot, in other words an assembly robot, or a part of a manufacturing robot. The control signal can, for example, be generated during the production of the assembly, i.e., before the actual state of the assembly is recorded, and sent to the actuator. In this context, the actuator is designed to produce or assemble at least part of the assembly according to the digital double. In addition to the actuator or robot, further actuators and/or robots can be provided, which are designed to produce the assembly according to the digital twin. For example, a manufacturing robot may have several of the actuators. Accordingly, the control signal can be configured to control multiple actuators, and/or multiple control signals can be generated for the corresponding multiple actuators and sent to them. The control signal can alternatively or additionally be generated as a result of the generation of the error signal, in which case the actuator is designed to at least partially correct the deviation.

According to one embodiment, the actuator is further designed to change the actual state of the assembly according to a specified scheme; and to adapt the specified scheme depending on the deviation such that the deviation is reduced or eliminated. The given scheme can, for example, include the digital doppelganger. Accordingly, the digital doppelganger can be adjusted to reduce or prevent future deviations. Alternatively or additionally, the specified scheme may have one or more characteristic curves, on the basis of which the actuator generates its movement(s) in response to the control signal.

Accordingly, the actuator would then execute a more or less changed movement in response to the same control signal. Alternatively or additionally, the specified scheme may comprise one or more settings of the actuator. For example, if the actuator performs a movement in a certain direction and/or with a certain amplitude, the direction and/or amplitude can be specified by the scheme and changed when the scheme is adapted. For example, if the actuator is used to fasten a fastener, such as a screw or a rivet, to the assembly, a force that the actuator applies to carry out the fastening can, for example, be specified by the scheme and changed when the scheme is adapted. For example, if the actuator is used to feed a lubricant to the assembly, the amount of lubricant to be fed can, for example, be specified by the scheme and changed when the scheme is adapted. For example, if the actuator is used to feed a component to the assembly and/or to fasten the component to the assembly, the type of component and/or the region of the assembly to which the component is to be fastened can be specified by the scheme and changed when the scheme is adapted.

According to one embodiment, the system further comprises: a gate-like carrier device with a gate opening, through which the assembly can be moved relative to the carrier device and on which the sensors are arranged such that at least one of the sensors faces the gate opening. The gate-like carrier device with the sensor(s), which are at least partially aligned toward the gate opening, helps ensure that the actual state of the assembly can be fully and automatically recorded by means of the sensors on the carrier device. In particular, the actual state can be recorded simultaneously from multiple directions, in particular in 3D, by means of the sensors on the gate-like carrier device. The carrier device being “gate-like” means, for example, that the carrier device has the shape of a gate, for example rounded in the shape of an upside-down “U” or in the shape of a rectangle open at the bottom, and/or that the assembly can be guided through the gate opening, like a vehicle can be driven through a gate.

According to one embodiment, the system further comprises: a transport device, which is mechanically coupled to the assembly and/or to the gate-like carrier device such that the assembly can be moved through the gate opening relative to the gate-like carrier device by means of the transport device. The transport device can help ensure that the actual state of the assembly can be fully and automatically recorded by means of the sensors on the carrier device. The transport device can, for example, comprise a conveyor belt, on which the assembly can be arranged and by means of which the assembly can be transported through the gate opening. Alternatively or additionally, the transport device may comprise a transport system for moving the carrier device. For example, the transport device can have a rail system and a drive, by means of which the carrier device can be moved along the assembly.

According to one embodiment, at least one of the sensors is an optical sensor. Alternatively or additionally, at least one of the sensors generates a sensor signal that is representative of the distance between the assembly and the sensor. Optionally, the optical sensor can be the sensor that generates the sensor signal representative of the distance of the assembly to the sensor. In this context, the sensor can be described as an optical sensor with depth determination. Such a sensor may, for example, be designed as a time-of-flight (TOF) camera. Alternatively, the sensor that generates the sensor signal that is representative of the distance between the assembly and the sensor may be an ultrasonic sensor. In other words, the sensor generating the sensor signal such that it is representative of the distance between the assembly and the sensor can mean that the sensor provides depth information. This depth information is representative of how far a region of the assembly currently being scanned by the sensor is from the sensor. Since the positions of the sensors are generally known, the depth information can be used to determine exactly where the corresponding region is currently located. Together with image data, which are recorded by means of the optical sensor, or on the basis of the image data with depth information, it is then possible to determine very precisely, in particular in three dimensions, where each component of the assembly is located.

According to one embodiment, the system further comprises: the provision device, which is communicatively coupled to the control unit and which is designed, in response to a provision signal from the control unit, to retrieve the component that is missing from the assembly from the warehouse and to provide it at the removal station.

According to one embodiment, the system further comprises: the removal station for providing the missing component.

### BRIEF DESCRIPTION OF THE DRAWINGS

Embodiments of the invention will be described below with reference to the accompanying drawings, wherein neither the drawings nor the description are intended to be interpreted as limiting the invention.

FIG. 1 shows a side view of an assembly for a passenger transport system and a system for checking and fault-correcting in the manufacturing of the assembly of the passenger transport system, according to an embodiment of the present invention.

FIG. 2 shows a front view of the system according to FIG. 1.

FIG. 3 shows a block diagram illustrating a function of a control unit of the system according to FIG. 1, according to an embodiment of the present invention.

FIG. 4 shows a flowchart of an exemplary embodiment of a method for checking and fault-correcting in the manufacturing of the assembly of the passenger transport system, according to an embodiment of the present invention.

The figures are merely schematic and not true to scale. In the various figures, identical reference signs denote identical or similar features.

### DETAILED DESCRIPTION OF THE DRAWINGS

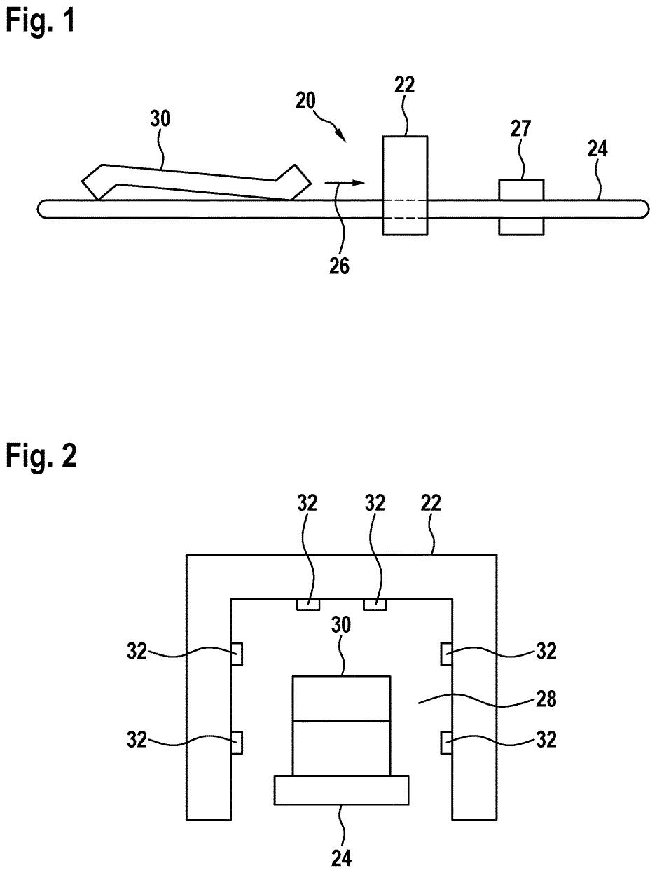

FIG. 1 shows a side view of an assembly 30 of a passenger transport system and a system 20 for checking and fault-correcting in the manufacturing of the assembly 30 for the passenger transport system, according to an embodiment of the present invention. The passenger transport system is suitable for transporting passengers between different height levels or within a constant height level, for example in buildings. The passenger transport system can, for example, be an escalator, in particular moving stairs, an elevator system or a moving walkway. The assembly 30 can comprise the complete prefabricated passenger transport system, which is not yet arranged at its destination. Alternatively, the assembly 30 may comprise a part of the passenger transport system, for example a support structure, a shaft module, a drive unit, or an elevator car.

The system 20 is designed to subject the assembly 30 to a thorough inspection at the end of a production line for manufacturing the assembly 30. In particular, the system 20 can be used to automatically check and/or inspect whether all components of the assembly 30 are correctly arranged, aligned, and/or connected to one another. For example, in the case of a passenger transport system designed as an escalator or a moving walkway, a corresponding support structure of the passenger transport system can be checked by means of the system 20. Alternatively, in the case of an elevator as a passenger transport system, an elevator car and/or a shaft module of the corresponding elevator system may be checked automatically by means of the system 20.

The system 20 has a gate-like carrier device 22. The gate-like carrier device 22 has a gate opening 28 (see FIG. 2), through which the assembly 30 can be moved relative to the carrier device 22. The carrier device 22 being “gate-like” means, for example, that the carrier device 22 has the shape of a gate, for example rounded in the shape of an upside-down “U” or in the shape of a rectangle open at the bottom. The carrier device 22 being “gate-like” may alternatively or additionally mean that the assembly 30 can be guided through the gate opening 28, like a vehicle can be driven through a gate.

The system 20 further comprises a transport device 24, which is mechanically coupled to the assembly 30 and/or to the gate-like carrier device 22 such that the assembly 30 can be moved through the gate opening 28 relative to the gate-like carrier device 22 by means of the transport device 24. The transport device 24 can, for example, comprise a conveyor belt, on which the assembly 30 can be arranged and by means of which the assembly 30 can be transported in a movement direction 26 through the gate opening 28. Alternatively or additionally, the transport device 24 may comprise a transport system for moving the carrier device 22. For example, the transport device 24 can have a rail system and a drive (not shown), by means of which the carrier device 22 can be moved against the movement direction 26 along the assembly 30. In this case, the assembly 30 can remain stationary. Alternatively, both the assembly 30 and the carrier device 22 can be moved, namely, such that a relative movement occurs between the assembly 30 and the carrier device 22.

The system 20 further comprises a removal station 27 for providing one or more missing components for the assembly 30.

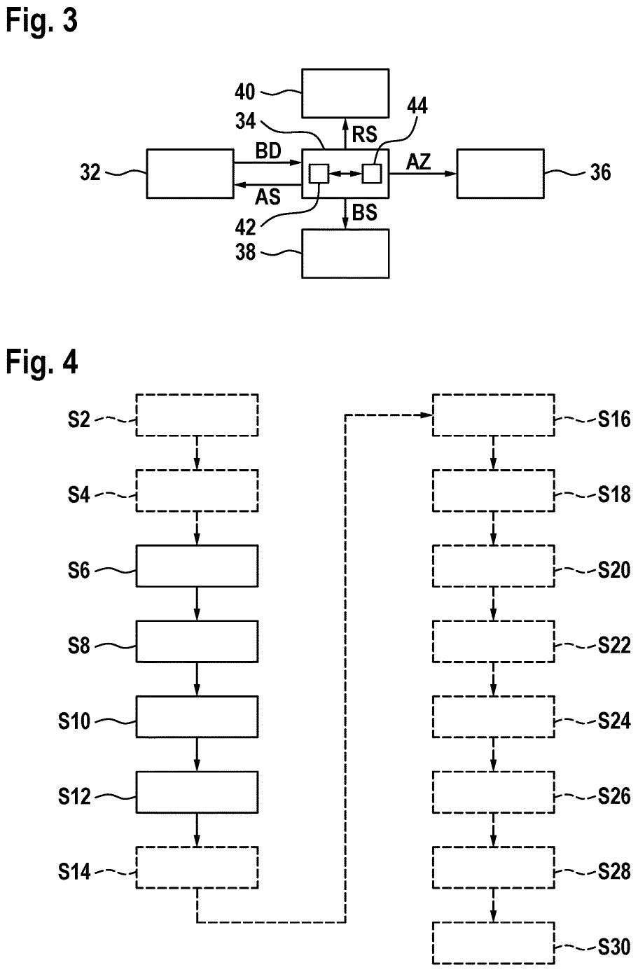

FIG. 2 shows a front view of the system 20 according to FIG. 1. FIG. 2 shows that the system 20 has multiple sensors 32. Depending on the configuration of the assembly 30 to be inspected, only one sensor 32 may be required. The sensors 32 are designed to scan, in other words record, the assembly 30. During the scanning of the assembly 30, the sensors 32 can generate assembly data BD (see FIG. 3) that are representative of an actual state of the assembly 30. The sensors 32 are arranged on the carrier device 22 such that at least one of the sensors 32 faces the gate opening 28. By means of the sensors 32 on the gate-like carrier device 22, the actual state of the assembly 30 can be recorded simultaneously from multiple directions, in particular in three dimensions.

One or more of the sensors 32 may be optical sensors, such as light sensors, photocells or CCD cameras, and the like. Alternatively or additionally, at least one of the sensors 32 generates a sensor signal that is representative of the distance between the assembly 30 and the corresponding sensor 32. Optionally, the optical sensor may be the sensor 32 that generates the sensor signal that is representative of the distance between the assembly 30 and the sensor. In this context, the sensor 30 can be referred to as an optical sensor with depth determination. Such a sensor 32 may, for example, be designed as a radar sensor or lidar sensor or time-of-flight (TOF) camera. Alternatively, the sensor 32 that generates the sensor signal that is representative of the distance between the assembly 30 and the sensor 32 may be an ultrasonic sensor.

In other words, the sensor 32 generating the sensor signal such that it is representative of the distance between the assembly 30 and the sensor 32 can mean that the sensor 32 provides depth information. This depth information is representative of how far a region of the assembly 30 currently being scanned by the sensor 32 is from the sensor 32. Since the positions of the sensors 32 are generally known, the depth information can be used to determine exactly where the corresponding region is currently located. Together with image data, which can be recorded by means of the optical sensor, or on the basis of the image data with depth information, it is then possible to determine very precisely, in particular in three dimensions, where each component of the assembly 30 is located.

FIG. 3 shows a block diagram illustrating a function of a control unit 34 of the system 20 according to FIG. 1, according to an embodiment of the present invention. The control unit 34 forms a component of the system 20. The control unit 34 may also be referred to as the control unit 34 for the system 20 for checking and fault-correcting in the manufacturing of the assembly 30 for the passenger transport system. The control unit 34 comprises a storage unit 44 for storing the assembly data BD as well as a digital double of the assembly 30. In addition, the control unit 34 comprises a program, which is stored at least temporarily in the storage unit 44, with the implemented method as well as a processor 42, which is communicatively coupled to the storage unit 44 and which is designed to execute the method implemented in the program and explained with reference to FIG. 4.

The control unit 34 is designed to communicate with the sensors 32, for example, wired or wireless. For example, the control unit 32 can be designed to send an activation signal AS to the sensors 23 and/or to receive the assembly data BD from the sensors 32.

The system 20 further comprises a display unit 36, a provision device 38, and/or an actuator 40. The display unit 36 may, for example, comprise an optical and/or an acoustic display unit. The optical display can, for example, be a system monitor, AR glasses, a tablet computer, a laptop or a mobile phone of a technician of the assembly 30. The control unit 34 can be designed to send a display signal AZ to the display unit 36. The display unit 36 can be designed, in response to receiving the display signal AZ, to display content encrypted in the display signal AZ.

The provision device 38 is communicatively coupled to the control unit 34 and is designed, in response to a provision signal BS of the control unit 34, to retrieve a component that is missing from the assembly 30 from a warehouse and to provide it at the removal station 27 (see FIG. 1). The provision device 38 can, for example, comprise a warehouse robot, which is designed, in response to receiving the provision signal BS, to automatically retrieve the missing component from the warehouse and to provide it at the removal station 27. Alternatively or in combination, the provision signal BS can also be displayed on the display unit 36 and can contain information about the missing component, such as its dimensions, component number, and the like.

The actuator 40 may, for example, be a manufacturing robot or a part of a manufacturing robot. The manufacturing robot may have multiple actuators 40. Furthermore, the control unit 34 can be communicatively coupled to multiple manufacturing robots and/or actuators 40 and can send control signals RS to them.

The components of the system 20 shown in FIG. 3 can be implemented by means of hardware and/or software. These components can exchange data with one another and, if necessary, with one or more further platforms, such as a central computer, a computer network, and/or the cloud, via known data interfaces, either in a wired and/or wireless manner.

FIG. 4 shows a flowchart of an exemplary embodiment of a method for checking and fault-correcting in the manufacturing of the assembly 30 for the passenger transport system, according to an embodiment of the present invention. The method can, for example, be carried out by the control unit 34 of the system 20 for checking and fault-correcting in the manufacturing of the assembly of the passenger transport system, in particular automatically, i.e., without human intervention.

In an optional step S2, a start signal can be received, in particular by the control unit 34. The start signal is representative of the actual state of the assembly 30 being recordable. Before recording the actual state, the assembly 30 can be arranged in the system 20 for checking and fault-correcting in the manufacturing of the assembly 30 for the passenger transport system. For example, for recording the actual state, the assembly 30 can be arranged on a dedicated placement unit of the system 20. The placement unit can be part of the transport device 24. As a result, the start signal can, for example, be generated manually by means of a corresponding input, for example by the technician via an input unit, or automatically, for example by means of one or more sensors, for example the aforementioned sensors 32, and sent to the control unit 34 when the assembly 30 is arranged as intended in the system 20. This ensures that the actual state of the assembly 30 is recorded only if the assembly 30 is arranged as intended in the system 20.

In an optional step S4, the activation signal AS can be sent to one or more of the sensors 32. Illustratively speaking, the scanning process by means of the sensors 32 can be initiated by the control unit 34 by the control unit 34 sending the activation signal AS to the sensors 32. After receiving the activation signal AS, the sensors 32 record the actual state of the assembly 30. The recording of the assembly 30 comprises scanning the assembly 30 by means of the sensor(s) 32. The scanning may, for example, comprise optical scanning by means of an optical sensor and/or acoustic scanning by means of an acoustic sensor of the sensors 32. The optical sensor can, for example, be a radiation sensor that detects electromagnetic radiation, for example in the visible light spectrum or in the infrared range. Thus, the optical sensor can be, for example, a light sensor, such as a CCD camera, or an infrared sensor. The acoustic sensor can, for example, be a microphone that detects acoustic waves, for example in the audible range or in the ultrasonic range. Thus, the acoustic sensor can be, for example, a microphone or an ultrasonic sensor. The sensor 32 can optionally also obtain the depth information.

In a step S6, the assembly data BD, which are representative of the actual state of the assembly 30, can be received. In particular, the control unit 32 can receive the assembly data BD.

In a step S8, the received assembly data BD can be compared with a digital double of the assembly 30, which is representative of a target state of the assembly 30. In particular, the control unit 32 can compare the received assembly data BD with the digital double.

The comparison of the received assembly data BD with the digital double can in particular comprise finding one or more differences between the received assembly data BD and the digital double. The comparison of the received assembly data BD with the digital double is carried out automatically. This automatic comparison can be performed using a conventionally programmed algorithm. Alternatively, the automatic comparison can be performed by means of artificial intelligence and/or machine learning. For example, a program for creating the digital double can create a plurality of digital doubles in which one or more components are missing or too many, and/or are not installed as intended. These “faulty” digital doubles can then be used, as assembly data BD of correspondingly putatively faulty assemblies 30, to train the artificial intelligence so that, after training, the artificial intelligence is able to detect one or more deviations of the actual state from the target state on the basis of the received assembly data BD and the digital double.

The digital double can also be referred to as a digital twin. The digital double is represented by a corresponding digital data set, for example referred to as the twin data. The double data can be stored in the storage unit 44 and retrieved by the processor when needed. The digital double can, for example, be generated and stored as described in the prior art mentioned at the outset. Alternatively, other methods known from the prior art can also be used to create the digital double.

In a step S10, a release signal, which is representative of the actual state corresponding to the target state, can be generated if the comparison shows that the actual state corresponds to the target state. In particular, the control unit 32 can generate the release signal. The release signal can be transmitted from the control unit 34, for example, to the display unit 36, for example in the form of the display signal AZ. In this case, the display unit 36 can be used to indicate to a technician of the assembly 30 that the assembly 30 is in perfect condition.

In a step S12, an error signal, which is representative of a deviation of the actual state from the target state, can be generated if the comparison shows that the actual state does not correspond to the target state. In particular, the control unit 32 can generate the error signal. The error signal may be transmitted from the control unit 34 to one or more other units, as explained in more detail below.

In an optional step S14, the display signal AZ can be generated depending on the error signal and sent to the display unit 36, which is designed to display the deviation of the actual state from the target state in response to receiving the display signal AZ. The display signal AZ can, for example, be representative of where and/or how the actual state deviates from the target state. The display signal AZ being generated depending on the error signal can, in the simplest case, mean that the error signal is used as the display signal AZ or, in casual terms, that the error signal is looped through as the display signal AZ. This is possible if the display unit 36 is able to correctly interpret the error signal. Otherwise, the display signal AZ can be generated depending on the error signal, the display signal AZ being generated in a format that can be correctly interpreted by the display unit 36 and that contains the same information content as the error signal, namely, which deviation exists where.

In an optional step S16, the provision signal BS can be generated depending on the error signal and sent to the provision device 38 if the deviation consists in a component being missing from the assembly 30. The provision signal BS can be representative of the missing component so that the provision signal BS can be used to identify which component is missing, and where. The provision device 38 is designed to retrieve the missing component from a warehouse (not shown) and to provide it at the removal station 27. The provision signal BS being generated depending on the error signal can, in the simplest case, mean that the error signal is used as the provision signal BS or, in casual terms, that the error signal is looped through as the provision signal BS. This is possible if the provision device 38 is able to correctly interpret the error signal. Otherwise, the provision signal BS can be generated depending on the error signal, the provision signal BS being generated in a format that can be correctly interpreted by the provision device 38 and that contains the same information content as the error signal, namely, which component is missing.

In an optional step S18, a control signal RS for the actuator 40 can be generated and sent to the actuator 40. The actuator 40 can be designed to change the actual state of the assembly 30 on the basis of the digital double. The control signal RS can be generated as a result of the generation of the error signal, in which case the actuator 40 is designed to at least partially correct the deviation. The control signal RS can, alternatively or additionally, be generated during the production of the assembly 30, i.e., before the actual state of the assembly 30 is recorded, and sent to the actuator 40. In this context, the actuator 40 can be designed to produce or assemble at least part of the assembly 30 according to the digital double. In addition to the actuator 40 or robot, further actuators and/or robots (not shown) can be provided, which are designed to produce the assembly 30 according to the digital double.

Optionally, the actuator 40 can be further designed to change the actual state of the assembly 30 according to a specified scheme and to adapt the specified scheme depending on the deviation such that the deviation is reduced or eliminated in the manufacturing of future similar passenger transport systems 30. The given scheme can, for example, include the digital doppelganger. Alternatively or additionally, the specified scheme may have one or more characteristic curves, on the basis of which the actuator 40 generates its movement(s) in response to the control signal RS. Alternatively or additionally, the specified scheme may comprise one or more settings of the actuator 40. For example, if the actuator 40 performs a movement in a certain direction and/or with a certain amplitude, the direction and/or amplitude can be specified by the scheme and changed when the scheme is adapted. For example, if the actuator 40 is used to fasten a fastener, such as a screw or a rivet, to the assembly 30, a force that the actuator 40 applies to carry out the fastening can, for example, be specified by the scheme and changed when the scheme is adapted. For example, if the actuator 40 is used to feed a lubricant to the assembly 30, the amount of lubricant to be fed can, for example, be specified by the scheme and changed when the scheme is adapted. For example, if the actuator 40 is used to feed a component to the assembly 30 and/or to fasten the component to the assembly 30, the type of component and/or the region of the assembly 30 to which the component is to be fastened can be specified by the scheme and changed when the scheme is adapted.

In an optional step S22, the release signal can be used to remove the checked and, if necessary, fault-corrected assembly 30 from the system 20 and to retrieve the next assembly 30 to be checked.

Steps S14 to S20 can be processed in any order or simultaneously. Furthermore, steps S14 to S18 can be executed before or after the steps described below.

In an optional step S22, it can be checked depending on the error signal whether the same deviation has already occurred in previously inspected similar assemblies 30, for example by means of the control unit 34.

If step S22 is carried out, it can be checked in a step S24 whether a number of the previously occurred identical deviations is greater than a specified threshold value, if the same deviation has already occurred in previously inspected similar assemblies 30. The threshold value can be specified by the manufacturer of the passenger transport system. The deviations of the previously inspected similar assemblies 30 can, for example, be stored in the storage unit 44 of the control unit 34 and retrieved from the storage unit 44 when checking whether the same deviation has already occurred in previously inspected similar assemblies 30.

If steps S22 and S24 are carried out, a cause of the deviation can be determined in a step S26 if the number is greater than the specified threshold value. For example, historical data and/or a lookup table can be used to determine which cause(s) have already led to a similar deviation. Furthermore, artificial intelligence can be trained, for example, using historical data that show which cause(s) have led to which deviations, such that it can determine the cause of the deviation with a high degree of probability.

If steps S22 to S26 are carried out, a procedure for eliminating the cause can be determined in a step S28. For example, historical data and/or a lookup table can be used to determine which procedure(s) have already been carried out for eliminating a similar cause. Furthermore, artificial intelligence can be trained, for example, using historical data that show which procedure(s) have already been used for eliminating a similar cause, such that it can determine and recommend the appropriate procedure with a high degree of probability.

If steps S22 to S28 are carried out, an instruction signal that is representative of the procedure for eliminating the cause can be generated in a step S30. The instruction signal can be a signal for the display unit 36, which, in response to receiving the instruction signal, recommends to the technician the procedure for eliminating the cause. Alternatively, the instruction signal can be a signal for the assembly robot, which, in response to receiving the instruction signal, makes at least one change in the assembly of future similar assemblies 30.

If the same deviation has not yet occurred in previously inspected similar assemblies 30, checking whether the number of previously occurred identical deviations is greater than the specified threshold value, and the subsequent determination of the cause, determination of the procedure, and generation of the instruction signal can be omitted. If the number is not greater than the specified threshold value, the determination of the cause, the determination of the procedure, and the generation of the instruction signal can be omitted.

Finally, it should be noted that terms such as “having,” “comprising,” etc. do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1. A method for checking and fault-correcting in the manufacturing of an assembly for a passenger transport system, which is configured as an elevator, escalator or a moving walkway, the method comprising:
receiving assembly data generated by one or more sensors, the assembly data representing an actual state of the assembly
comparing the received assembly data to a digital double of the assembly in a control unit, the digital double of the assembly representing a target state of the assembly;
generating a release signal by the control unit which release signal represents the actual state corresponding to the target state, if the comparison shows that the actual state corresponds to the target state;
generating an error signal by the control unit, which error signal represents a deviation of the actual state from the target state, if the comparison shows that the actual state does not correspond to the target state;
generating a provision signal based on the error signal if the deviation is due to a component being missing from the assembly, the provision signal representing the missing component; and
sending the provision signal to a provision device, which is configured to retrieve the missing component from a warehouse and to provide it at a removal station.

2. The method according to claim 1, comprising, before the reception of the assembly data:
sending an activation signal to one or more sensors. configured to record the actual state of the assembly in response to receiving the activation signal

3. The method according to claim 2, comprising, before the sending of the activation signal:
receiving a start signal, the start signal being representative of the actual state of the assembly being recorded.

4. The method according to claim 1, further comprising:
generating a display signal based on the error signal, the display signal being representative of where and/or how the actual state deviates from the target state; and
sending the display signal to a display unit configured to display the deviation of the actual state from the target state in response to receiving the display signal.

5. (canceled)

6. The method according to claim 1, further comprising:
checking whether the same deviation has already occurred in previously inspected similar assemblies based on the error signal;
checking whether a number of the previously occurred identical deviations is greater than a specified threshold value, if the same deviation has already occurred in previously inspected similar assemblies;
determining the cause of the deviation if the number is greater than the specified threshold value;
determining a procedure for eliminating the cause; and
generating an instruction signal representing the procedure for eliminating the cause.

7. The method according to claim 1, further comprising:
generating at least one control signal for an actuator configured to change the actual state of the assembly based on the digital double; and
sending the control signal to the actuator.

8. The method according to claim 7, wherein the actuator is further configured to change the actual state of the assembly according to a specified scheme; and
the specified scheme is adapted based on the deviation such that the deviation is reduced or eliminated.

9. A control unit for a system for checking and fault-correcting in the manufacturing of an assembly for a passenger transport system, which is configured as an elevator, escalator or a moving walkway, the control unit comprising:
a storage unit for storing assembly data of the passenger transport system, the assembly data representing an actual state of the assembly, and for storing a digital double of the assembly a program, stored at least temporarily in the storage unit, with the implemented method according to claim 1; and
a processor, which is communicatively coupled to the storage unit and which is configured to execute the method implemented in the program.

10. A system for checking and fault-correcting in the manufacturing of an assembly for a passenger transport system, which is configured as an elevator, escalator or a moving walkway, the system comprising:
one or more sensors configured to generateing assembly data of the passenger transport system, said assembly data representing an actual state of the assembly; and
a control unit according to claim 9.

11. The system according to claim 10, further comprising:
a gate-like carrier device with a gate opening, through which the assembly can be moved relative to the carrier device and on which the one or more sensors are arranged such that at least one of the sensors faces the gate opening.

12. The system according to claim 11, further comprising:
a transport device, which is mechanically coupled to the assembly and/or to the gate-like carrier device, such that the assembly can be moved through the gate opening relative to the gate-like carrier device using the transport device.

13. The system according to claim 10, wherein
at least one of the sensors is an optical sensor, and/or
at least one of the sensors generates a sensor signal representing the distance between the assembly and the sensor.

14. The system according to claim 10, further comprising:
a provision device communicatively coupled to the control unit, the provision device being configured, in response to a provision signal of the control unit, to retrieve a component that is missing from the assembly from a warehouse and to provide it at a removal station.

15. The system according to claim 14, further comprising:
the removal station for providing the missing component.
